(19) United States
(12) Patent Application Publication
(10) Pub. No.: US 2010/0188257 A1
(43) Pub. Date: Jul. 29, 2010

(54) IN-HOME DISPLAY

(75) Inventor: Matthew Johnson, Spokane, WA (US)

Correspondence Address: DORITY & MANNING, P.A., POST OFFICE BOX 1449, GREENVILLE, SC, 29602-1449, US

(73) Assignee: ITRON, INC., Liberty Lake, WA (US)

(21) Appl. No.: 12/362,437

(22) Filed: Jan. 29, 2009

(51) Int. Cl. G08C 15/06

(52) U.S. Cl. 340/870.02

(57) ABSTRACT

Generally described, the disclosed subject matter is directed to providing enhanced features regarding the consumption of utility services. In accordance with one embodiment, a method is provided for obtaining a specified time interval of consumption data using the two-way communication ability of a utility meter. Specifically, the method includes capturing network traffic originating from the utility meter that contains consumption data. Then, processing is performed to identify any intervals of consumption data that were not successfully collected. If an interval of consumption data was not successfully collected when transmitted at a scheduled time, the method generates and sends a request to the utility meter to obtain the omitted interval.

### BACKGROUND

Through advancements in the metering infrastructure, the collection of meter readings that quantify the consumption of utility services (i.e., natural gas, water, electricity, etc.) is being automated. In this regard, utility meters may be configured with an Encoder Receiver Transmitter (“ERT”) that collects and encodes meter readings for transmission to a utility service provider. Utility meters configured to communicate consumption data in this way are commercially available and increasingly being installed in homes, businesses, and the like. Generally stated, advancements in the metering infrastructure offer opportunities to provide enhanced services to consumers regarding their utility services.

Transmission of readings from a utility meter may be intercepted and processed by “in-home displays.” Generally described, an in-home display receives transmitted meter readings and provides consumers with real-time access to consumption data. As a result, consumers are more readily able to conserve resources, determine whether utility services have been interrupted, and the like. However, existing in-home displays are not configured to fully utilize the two-way communication capabilities available from some utility meters. In this regard, interference sources may exist that prevent an in-home display from obtaining consumption data for a particular time interval. Without utilizing the two-way communication abilities available from some utility meters, existing in-home displays are unable to provide a complete consumption profile. Further, upon the occurrence of disruption of service or other event, for example, if the event was a disruption in electricity services, certain communication media (radio, television, Internet, etc.) may not be available to consumers. Transmission of messages over a metering infrastructure would allow a utility service provider to communicate with consumers in a way that is not dependent on utility services. However, existing systems are not configured to utilize dissimilar networks and/or protocols to transmit messages between a utility service provider and an in-home display.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Generally described, the disclosed subject matter is directed to providing enhanced features regarding the consumption of utility services. In accordance with one embodiment, a method is provided for obtaining a specified time interval of consumption data using the two-way communication ability of a utility meter. Specifically, the method includes capturing network traffic originating from the utility meter that contains consumption data. Then, processing is performed to identify any intervals of consumption data that were not successfully collected. If an interval of consumption data was not successfully collected when transmitted at a scheduled time, the method generates and sends a request to the utility meter to obtain the omitted interval.

In accordance with another embodiment, an in-home display is provided for obtaining consumption data from a remote device. The display comprises a processor, a radio-based communication system for communicating data between the in-home display and the remote device, and a computer-readable media having computer-executable instructions. The computer-executable instructions, when executed by the processor, cause the in-home display to: collect one or more transmissions of data from the remote device that quantifies the consumption of a utility service; determine whether consumption data for each time interval within a consumption profile period was collected; and if consumption data for a time interval within the consumption profile period was not collected, utilize metering protocols to query and obtain the omitted time interval from the remote device.

In accordance with another embodiment, a metering system is provided for transmitting a message from a utility service provider to an in-home display. The system comprises a host server configured to create and instigate transmission of a message over a wide area network, a collection device configured to receive the message from the host server in a first format utilized to transmit the message over a wide area network, and cause the message to be transmitted to an in-home display in one or more encoded packets that utilize metering protocols, and an in-home display configured to receive and decode one or more packets that adhere to metering protocols, identify the one or more packets that contain the message received from the collection device, and implement processing to cause the message to be displayed on a user interface.

### DESCRIPTION OF THE DRAWINGS

The foregoing aspects and many of the attendant advantages of the claimed subject matter will become more readily appreciated by reference to the following detailed description, when taken in conjunction with the accompanying drawings, wherein:

FIG. 1 is a block diagram depicting an illustrative metering environment suitable for collecting data at an in-home display;

FIG. 2 is a block diagram illustrating components of an in-home display;

FIG. 3 is a flow diagram of one exemplary routine for providing a consumption profile on an in-home display; and

FIG. 4 is a flow diagram of one exemplary routine for allowing a utility service provider to transmit messages to an in-home display.

### DETAILED DESCRIPTION

The detailed description set forth below in connection with the appended drawings is intended as a description of various embodiments of the disclosed subject matter and is not intended to represent the only embodiments. Each embodiment described in this disclosure is provided merely as an example or illustration and should not be construed as preferred or advantageous over other embodiments. In this regard, the following description first provides an overview of a metering environment in which the disclosed subject matter may be implemented. Then, several examples of routines used to provide an enhanced in-home display are described. The illustrative examples provided herein are not intended to be exhaustive or to limit the invention to the precise forms disclosed. Similarly, any steps described herein may be interchangeable with other steps, or combinations of steps, in order to achieve the same or substantially similar result.

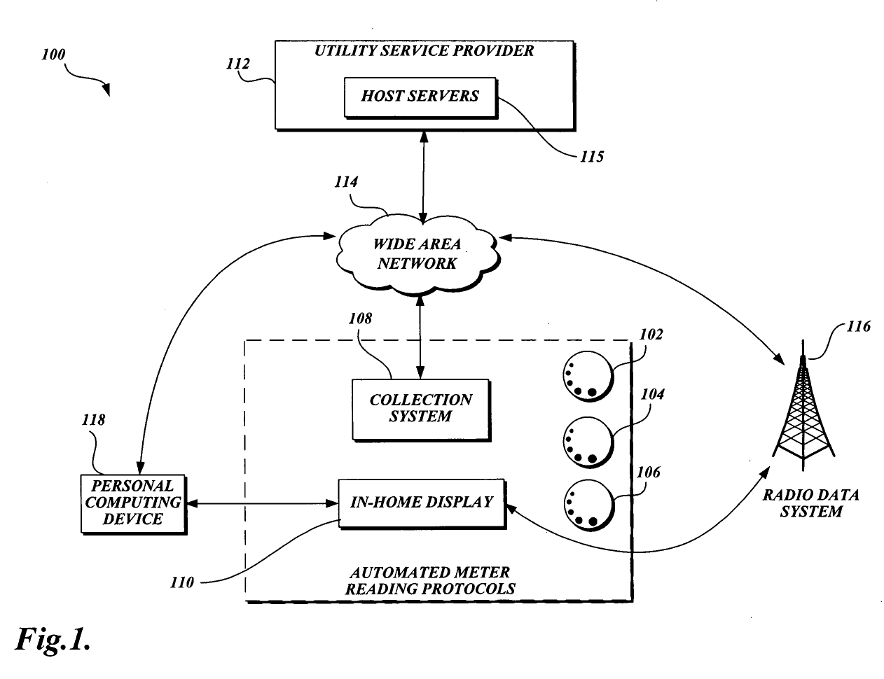

Referring to FIG. 1, the following is intended to provide a general overview of one embodiment of a metering environment 100 in which aspects of the disclosed subject matter may be implemented. Specifically, the metering environment 100 depicted in FIG. 1 includes a plurality of utility meters 102, 104, and 106, which may be gas meters, water meters, electric meters, or any other device capable of transmitting/receiving wired or wireless communications. In the embodiment depicted in FIG. 1, the utility meters 102-106 are configured to perform communications with the collection system 108 and the in-home display 110 utilizing automated meter reading protocols. Depending on the exact configuration and types of devices used, the utility meters 102-106 transmit data either periodically (“bubble-up”), in response to a wake-up signal, or in a combination/hybrid configuration. In each instance, the utility meters 102, 104, and 106 are configured to exchange data with the collection system 108 and the in-home display 110.

The collection system 108 may employ any number of automated meter reading protocols and devices to communicate with the utility meters 102-106. In this regard, the collection system 108 may be a fixed network comprised of Cell Control Units (“CCU”) that collect radio-based meter readings within a particular geographic area. In this regard, meter readings received from the utility meters 102-106 may be processed and forwarded by a CCU to a utility service provider 112. By way of another example, the collection system 108 may be a mobile control unit (e.g., utility vehicle) configured with a radio transceiver for collecting meter readings within a drive-by coverage area. Those skilled in the art and others will recognize that the collection of meter readings may be performed utilizing other collection systems (e.g., mesh/micro networks, handheld devices, Telephone-Base, computing devices, etc.) and the examples provided herein should be construed as exemplary. In the embodiment depicted in FIG. 1, the collection system 108 is configured to forward meter readings to the utility service provider 112 over a wide area network 114 which may be implemented utilizing TCP/IP Protocols (e.g., Internet), GPRS or other cellular-based protocols, Ethernet, WiFi, Broadband Over Power Line, and combinations thereof, etc. In one aspect, the collection system 108 serves as the bridge for transmitting data between devices that utilize automated meter reading protocols (e.g., the utility meters 102-106 and the in-home display 110) with computers (e.g., the host servers 115) coupled to the wide area network 114.

In one aspect, functionality is provided that allows the utility service provider 112 to communicate messages to the in-home display 110. The utility service provider 112 is able to instigate a message notification that is transmitted to the collection system 108 over the wide area network 114. The collection system 108 may forward the message directly to the in-home display 110 or route the message through one or more of the utility meters 102-106. In these instances, the automated meter reading protocols are utilized to communicate a message from the utility service provider 112 to the in-home display 110. In an alternative embodiment, a message may be communicated between the utility service provider 112 and the in-home display 110 utilizing a radio data system 116. Those skilled in the art and others will recognize that the radio data system 116 utilizes devices and protocols available in some geographic areas for sending relatively small amounts of digital information as an FM and/or AM radio broadcast. In this instance, the radio data system 116 is coupled to the wide area network 114 and processes messages originating from the utility service provider 112 for transmission to the in-home display 110. However, those skilled in the art and others will recognize that the radio data system 116 is only one representative technology that may be used to deliver messages that originate from the wide area network 114. For example, other technologies such as, but not limited to, the Short Message Service Cell Broadcast (SMS-PP), Short Message Service Point to Point (SMS-PP), paging services, and the like may also be utilized.

In one aspect, the in-home display 110 is configured to leverage the two-way communication capabilities of the utility meters 102-106 so that a complete profile of consumption data is collected. The utility meters 102-106 may be configured to transmit meter readings at particular intervals. If interference or other problems prevent the collection of data, the in-home display 110 may query the appropriate utility meter 102, 104, or 106 to obtain the missing data. Accordingly, all intervals of consumption data may be obtained by the in-home display 110 so that a complete consumption profile, having all relevant time intervals, may be provided to the consumer. Another feature of the in-home display 110 is the ability to interface with a personal computing device 118 utilizing common interfaces such as Universal Serial Bus (“USB”), WiFi, Bluetooth, IEEE 802.11, ZigBee, Ethernet, and the like. Utilizing the interface, meter readings collected by the in-home display 110 may be uploaded to the personal computing device 118 and accessed from a software application. Once uploaded to the personal computing device 118, the consumption data may also be forwarded to the utility service provider 112 over the wide area network 114. In addition, messages, software upgrades, and other data can be readily downloaded to the personal computing device 118 via the wide area network 14 for installation on the in-home display 110 via one or more common interfaces described above.

The discussion provided above with reference to FIG. 1 is intended as a brief, general description of one environment 100 capable of implementing various features of the disclosed subject matter. While the description above is made with reference to particular devices linked together through different interfaces, those skilled in the art will appreciate that the claimed subject matter may be implemented in other contexts. In this regard, the claimed subject matter may be practiced using different types of devices and communication interfaces than those illustrated in FIG. 1.

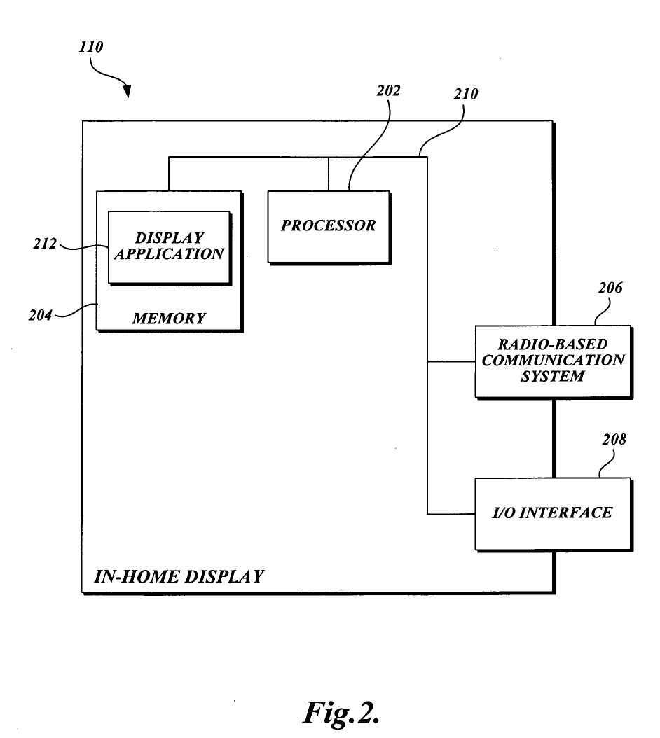

Now with reference to FIG. 2, an example component architecture for the in-home display 110 also depicted in FIG. 1 will be described. Specifically, the in-home display 110 includes a processor 202, a memory 204, connected by a communication bus 210. As further depicted in FIG. 2, the in-home display 110 includes a radio-based communication system 206 for transmitting/receiving wireless communications with other radio-based devices (e.g., the utility meters 102-106). Moreover, the in-home display 110 includes an I/O interface 208 for interfacing with a general purpose computing device such as the computing device 118 (FIG. 1). For ease of illustration, FIG. 2 does not depict transmitter and receiver circuitry, analog to digital converter, amplifier, power source, etc. that will typically be included with the radio-based communication system 206. However, since these and other components of the in-home display 110 are not relevant to the claimed subject matter they will not be described in detail here.

The memory 204 depicted in FIG. 2 is one example of computer-readable media suited to store data and program modules for implementing aspects of the claimed subject matter. As used herein, the term “computer-readable media” includes volatile and non-volatile and removable and non-removable memory implemented in any method or technology capable of storing information, such as computer-readable instructions, data structures, program modules, or other data. In this regard, the memory 204 depicted in FIG. 2 is one example of computer-readable media but other types of computer-readable media may be used. Those skilled in the art and others will recognize that the processor 202 serves as the computational center of the in-home display 110 by supporting the execution of instructions that are available from the memory 204. In the embodiment depicted in FIG. 2, the memory 204 includes a display application 212 having instructions suitable for being executed by the processor 202 to implement aspects of the disclosed subject matter.

In one embodiment, the display application 212 is configured with program logic that allows a complete consumption profile to be accessed from the in-home display 110. For example, when a meter reading is transmitted from a utility meter to the collection system 108, the communication may also be intercepted and stored on the in-home display 110 via the radio-based communication system 206. Processing is performed to determine whether consumption data for a particular interval was collected by the in-home display 110. If insufficient data for an interval was collected, the two-way communication abilities of a utility meter are utilized to obtain the missing data. In another embodiment, the display application 212 provides program logic that allows messages generated by a utility service provider to be presented on the in-home display 110. As described in further detail below, the messages may be pre-programmed and displayed based on the value in a bit field that identifies the appropriate message. Alternatively, new messages may be dynamically generated and transmitted from the utility service provider 112 for processing by the display application 212.

While certain functions described herein are illustrated as being implemented in a display application 212 executed on the in-home display 110, those skilled in the art and others will recognize that this is merely one example. In combination or separate from the display application 212, functionality described herein may be implemented within hardware devices such as application-specific integrated circuits (ASIC), digital signal processing (DSP) integrated circuits, programmed logic arrays, and the like.

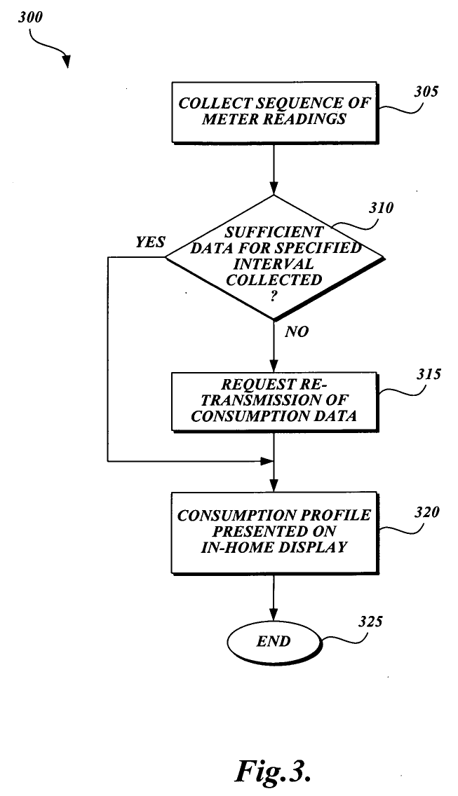

Now with reference to FIG. 3, one representative embodiment of a profiling routine 300 is provided. As depicted in FIG. 3, the profiling routine 300 begins at block 305 where data, such as a sequence of packets, containing meter readings are collected by the in-home display 110. In one embodiment, utility meters are configured to perform radio-based wireless transmission of meter readings. At installation or subsequently, a utility service provider may register and begin collecting data from the utility meter utilizing the collection system 108. As described above, the in-home display 110 includes components for listening to and capturing normal network traffic originating from a utility meter.

The in-home display 110 is configured to compile consumption data corresponding to a utility service for real-time access by the consumer. In this regard, meter readings in one embodiment are encoded as “packetized” data by the utility meters for transmission over the network. In the present application, the term “packet” is intended to encompass packets, frames, cells, messages or any other method used to encapsulate data for network transmission. As understood in the art, packets typically maintain a plurality of fields as well as a preamble and trailer to identify the beginning and end of the packet. In one embodiment, a packet encoded as a Network Interval Message (“NIM”) is transmitted from the utility meters 102-106 at regular intervals. The NIM packetized data maintains fields including an endpoint serial number field, a length field, a cyclic redundancy check (CRC) field, and the like. At block 305, meter readings that originate from a particular utility meter may be identified utilizing data in the endpoint serial number field of a NIM formatted packet. In this regard, a more detailed description of packet formats that may be used in conjunction with the routine 300 may be found in commonly-assigned, co-pending U.S. patent application Ser. No. ______ filed ______, entitled, “Filtering of Meter Reading Data.”

At decision block 310, a determination is made regarding whether sufficient consumption data for a specified interval was collected. Those skilled in the art and others will recognize that wireless communications are typically less reliable than communications performed over wired networks. In this regard, interference sources may exist that prevent meter readings data, such as a packet or series of packets originating from a utility meter from being collected by the in-home display 110. In intervals with a high failure rate in data transmission, data sufficient to provide a consumption profile over a particular interval may not initially be collected. In this regard, a consumption profile tracks the consumption of a utility service over time. If insufficient meter readers were received for a particular time interval (e.g. minutes, hours, days, etc.) that prevents a consumption profile from being generated, then the result of the test performed at block 310 is “no” and the profiling routine 300 proceeds to block 315. Conversely, if sufficient data was collected so that a consumption profile may be generated, the result of the test is “yes” and the profiling routine 300 proceeds to block 320, described in further detail below.

At block 315 of the profiling routine 300, consumption data that was not initially collected is obtained from a utility meter. Specifically, logic executed by the in-home display 110 identifies any intervals in which insufficient data was collected to generate a consumption profile. Then, the in-home display 110 establishes communications and queries the appropriate utility meter for consumption data over any missing intervals. As mentioned previously, the disclosed subject matter may be implemented in the context of a metering infrastructure in which utility meters are configured to not only report meter readings but also accept and respond to two-way communications. In one aspect, the disclosed subject matter extends existing automated meter reading protocols. Specifically, existing protocols are extended so that the in-home display 110 may utilize the two-way communication capabilities of a utility meter to request re-transmission of consumption data for a specified interval, at block 315.

At block 320, a consumption profile is made available to the consumer on the in-home display 110. Once block 320 is reached, processes have been executed to collect consumption data for each interval relevant to a consumption profile. The consumption data may be obtained (e.g., decoded from received packets) and presented on the in-home display in any number of different formats (e.g., text, graphics, etc.). In addition, controls available from the in-home display 110 may be used to navigate between intervals and otherwise access the consumption profile. Then, the profiling routine 300 proceeds to block 325, where it terminates.

It should be well understood that profiling routine 300 described above with reference to FIG. 3 does not show all of the functions performed within the metering environment 100 depicted in FIG. 1. Instead, the profiling routine 300 generally describes the commands and data exchanges performed to collect data used to provide a consumption profile on an in-home display. Those skilled in the art and others will recognize that some functions and/or exchanges of data described above may be performed in a different order, omitted/added, or otherwise varied without departing from the scope of the claimed subject matter. For example, in one embodiment, data collected by the in-home display, including the consumption profile described above, may be transmitted to the collection system from the in-home display either directly or through one or more utility meters.

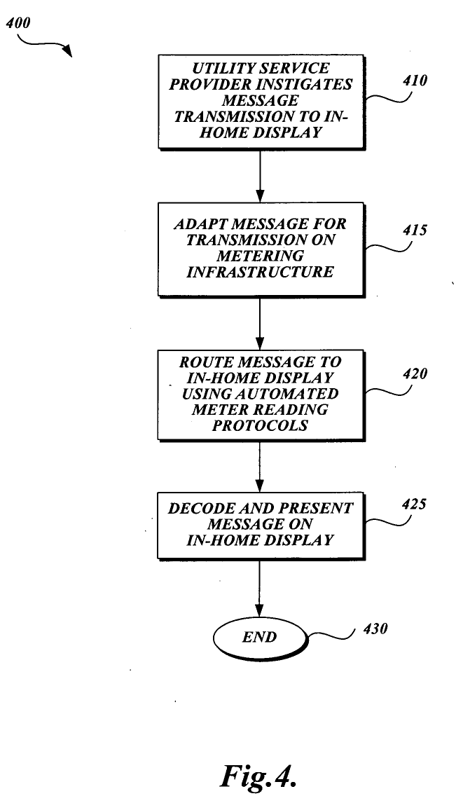

Now with reference to FIG. 4, a messaging routine 400 for performing communications between a utility service provider 112 and an in-home display 110 will be described. In any community, anomalous events such as utility service outages may affect some portion of the consumers in a geographic region. These events may range from relatively minor and/or localized occurrences to widespread outages or emergencies. In many cases, electrical and other utility services may be rendered inoperative making certain types of communications impossible. Generally described, the messaging routine 400 described with reference to FIG. 4 allows utility service providers to communicate messages to in-home displays in a way that both leverages and extends the capabilities of the existing metering infrastructure. These messages may be communicated in response to anomalous events as described above. Moreover, messages may be transmitted that provide seasonal conservation reminders, facilitate billings by providing account balances, and the like.

As illustrated in FIG. 4, the messaging routine 400 begins at block 410 where a utility service provider processes and instigates transmission of a message to one or more in-home displays. In one embodiment, the utility service provider 112 maintains the host servers 115 with associated data stores and host processing software for collecting consumption data, facilitating billings, and the like. In this regard, data available to the host servers 115 may be filtered to identify a relevant set of consumers. Instead of broadcasting a message to all consumers, filtering is performed to create and only transmit messages to a relevant set of consumers. By way of example only, this filtering may include identifying consumers within a particular geographic area and/or identifying consumers affected by a utility service disruption. Then, once the appropriate message recipients have been identified, individual messages directed to each identified message recipient and/or multiple recipients are encoded and transmitted over the wide area network 114.

At block 415, a message being communicated from a utility service provider to an in-home display is adapted for transmission over a metering infrastructure. In an illustrative embodiment, the message generated by the utility service provider 112, at block 410, is forwarded to the collection system 108 (e.g., CCU) for subsequent routing to an in-home display. In this regard, the CCU is configured to accept and convert data, such as packet data, formatted for the wide area network 114 into a communication that utilizes automated meter reading protocols. Specifically, the CCU includes an interface for performing two-way communications with the host servers 115 over the wide area network 114. In addition, the CCU includes an interface for encoding/decoding radio frames and performing communications with the utility meters 102-106 and the in-home display 110 (FIG. 1) utilizing automated meter reading protocols. Accordingly, the processing performed at block 415 includes accepting a message on a first interface and converting the message into a format suitable for being transmitted over a second interface.

At block 420 of the messaging routine 400, automated meter reading protocols are utilized to route a message to the in-home display 110. In particular, the messaging system is configurable with regard to how messages are routed to an in-home display 110. Specifically, a utility service provider may implement a configuration in which a message is directly communicated from the collection system 108 to the in-home display 110. Alternatively, the message may be transmitted to a utility meter 102, 104, or 106 from the collection system 108 and then forwarded to the in-home display 110. The exact configuration selected may depend on network and device variables that make a particular configuration preferable over another. However, different configurations are possible since the collection system 108, utility meters, and in-home display 110 are able to communicate utilizing a common set of protocols.

As mentioned previously with reference to FIG. 1, a message may be formatted and transmitted to the in-home display 110 without using the metering infrastructure. Specifically, the radio data system 116 may be coupled to the wide area network 114 and configured to forward messages received from a host servers 115 to the in-home display 110. In this instance, the radio data system 116 or other technology configured to perform communications over different networks would convert data, such as packets, formatted for the wide area network 114 into radio communications, at block 415. In this alternative embodiment, the radio data system 116 would then forward the message to the in-home display 110, at block 420.

At block 425 of the messaging routine 400, processing is performed to decode and present a message from a utility service provider 112 on the in-home display 110. To minimize the consumption of bandwidth and improve performance, the in-home display 110 may be pre-programmed with a set of commonly used messages (e.g., “Utility provider is aware of the power outage in your area,” “Power is expected be restored shortly,” etc.). In one embodiment, each pre-programmed message may be associated with a bit field in a packet that uniquely identifies the message. When a message transmission is received, the value of the bit field is identified and a lookup performed to identify the message content that will be displayed. In addition, dynamic content may be communicated either as a stand-alone message or to augment/configure a pre-programmed message. Then, once the message has been has been presented on the in-home display 110, the messaging routine 400 proceeds to block 430, where it terminates.

While embodiments of the claimed subject matter have been illustrated and described, it will be appreciated that various changes can be made therein without departing from the spirit and scope of the present disclosure.

The embodiments of the invention in which an exclusive property or privilege is claimed are defined as follows:

1. A method executed by a processor for obtaining a specified time interval of consumption data from a utility meter, the method comprising:
collecting network traffic originating from the utility meter that contains consumption data;
identifying an omitted interval of consumption data that was not collected when transmitted from the utility meter at a scheduled time;
generating and sending a command to the utility meter requesting the omitted interval of consumption data; and
receiving the requested interval of consumption data in response to the command.

2. The method as recited in claim 1, further comprising providing the consumer with real-time access to each interval of consumption data collected.

3. The method as recited in claim 1, further comprising providing controls that allow a user to navigate between intervals in which consumption data was collected.

4. The method as recited in claim 1, wherein generating and sending a command to the utility meter requesting the omitted interval of consumption data includes extending metering protocols so that a remote device may participate in two-way communications with a utility meter to request a specified interval of consumption data.

5. The method as recited in claim 1, wherein identifying an omitted interval of consumption data that was not collected when transmitted at a scheduled time includes decoding a sequence of packets that adhere to metering protocols and identifying any packets in the sequence that are not stored in the memory of an in-home display.

6. A metering system for transmitting a message from a utility service provider to an in-home display, comprising;
a host server configured to create and instigate transmission of a message over a wide area network;
a collection device configured to receive the message from the host server in a first format utilized to transmit the message over a wide area network, and cause the message to be transmitted to an in-home display in one or more encoded packets that utilize metering protocols; and
an in-home display configured to receive and decode one or more packets that adhere to metering protocols, identify the one or more packets that contain the message received from the collection device, and implement processing to cause the message to be displayed on a user interface.

7. The metering system as recited in claim 6, wherein the collection device is configured to convert the message into a second format suitable for transmission over a radio-based wireless network prior to causing the transmission of the message to the in-home display.

8. The metering system as recited in claim 7, wherein the collection device is a radio data system configured to receive the message from the utility service provider over the wide area network and route the message directly to the in-home display.

9. The metering system as recited in claim 6, wherein the collection device is a computing device configured to receive the message from the host server over the wide area network and route the message directly to the in-home display utilizing wired or wireless protocols.

10. The metering system as recited in claim 6, further comprising a utility meter configured to receive the message transmitted from the collection device and forward the message to the in-home display.

11. The metering system as recited in claim 6, wherein the collection device is configured to transmit the message directly to the in-home display without routing the message through an intervening device.

12. The metering system as recited in claim 6, wherein the in-home display includes one or more pre-programmed messages and wherein to cause the message to be displayed includes identifying an appropriate pre-programmed message based on an identifier obtained in a received packet.

13. The metering system as recited in claim 6, wherein the in-home display is configured to transmit data to the collection device either directly or through an intervening device.

14. An in-home display for obtaining consumption data from a remote device, comprising:
a processor;
a radio-based communication system for communicating data between the in-home display and the remote device;
a computer-readable media having computer-executable instructions that, when executed by the processor, cause the in-home display to:
collect one or more transmissions of data from the remote device that quantifies the consumption of a utility service;
determine whether consumption data for each time interval within a consumption profile period was collected; and
if consumption data for a time interval within the consumption profile period was not collected, utilize metering protocols to query and obtain the omitted time interval from the remote device.

15. The in-home display as recited in claim 14, wherein the computer-readable media further includes instructions that cause the in-home display to present a consumption profile on a user interface that quantifies the consumption of a utility service.

16. The in-home display as recited in claim 14, further including an I/O interface for communicating consumption data with a communicatively connected general purpose computing device.

17. The in-home display as recited in claim 14, wherein to collect one or more transmissions of consumption data includes intercepting and decoding packets transmitted wirelessly from a utility meter.

18. The in-home display as recited in claim 14, wherein to determine whether consumption data for each time interval was collected includes identifying packets in a sequence that are not stored on the computer-readable media.

19. The in-home display as recited in claim 14, wherein the computer-readable media further includes computer-executable instructions that, when executed by the processor, cause the in-home display to:
collect one or more transmissions of data from a remote device that forwards messages to the in-home display utilizing metering protocols, and
identify one or more packets in a received transmission that contains a message and perform processing to cause the message to be displayed on a user interface.

20. The in-home display as recited in claim 19, wherein the in-home display includes one or more pre-programmed messages and wherein the processing to cause the message to be displayed on a user interface includes performing a lookup to identify the appropriate pre-programmed message based on an identifier obtained in a received packet.
